(19) United States
(12) Patent Application Publication
(10) Pub. No.: US 2015/0277868 A1
(43) Pub. Date: Oct. 1, 2015

(54) DECLARED VARIABLE ORDERING AND OPTIMIZING COMPILER

(71) Applicant: International Business Machines Corporation, Armonk, NY (US)

(72) Inventor: Mark G. Cowtan, Ontario (CA)

(73) Assignee: International Business Machines Corporation, Armonk, NY (US)

(21) Appl. No.: 14/228,376

(22) Filed: Mar. 28, 2014

(51) Int. Cl. G06F 9/45

(52) U.S. Cl. CPC G06F 8/443

(57) ABSTRACT

A variable declaration is identified in a source code file. A variable is identified that is associated with a variable declaration. A location of first use of the variable in the source code is determined. The variable declaration is moved to a first location preceding the location of first use of the variable to optimize the source code.

### BACKGROUND

The present invention relates generally to compilers and more particularly to optimization of code using a compiler.

A compiler is a computer program, or set of programs, that translates source code, in a high-level programming language, into code of a lower level language, e.g., assembly language or machine language. Commonly, the output of a compiler has a form suitable for processing by another program, such as a linker, but it may also be output in a human readable format. The most common use of a compiler is to translate source code such that an executable program is generated. Compilers are likely to perform many, or all, of the following operations: lexical analysis, pre-processing, parsing, semantic analysis, code generation, and code optimization.

Programmers, by their nature and by methods taught to them while learning programming languages, tools and other job related requirements, are taught when writing source code to declare their variables at the beginning of the source code to help the compiler pick the right data types, data operations, etc. Functionally, moving the information to the top of the code ensures that when the compiler attempts to use declared variable “X” for storage enough space is allocated to fit values of “X” into memory.

### SUMMARY

Embodiments of the present invention include a method, computer program product, and system for optimizing code. In one embodiment, a variable declaration is identified in a source code file. A variable is identified that is associated with a variable declaration. A location of first use of the variable in the source code file is determined. Finally, the variable declaration is moved to a first location preceding the location of first use of the variable.

### BRIEF DESCRIPTION OF THE SEVERAL VIEWS OF THE DRAWINGS

FIG. 1 is a functional block diagram of a computer system in which embodiments of the present invention may operate.

FIGS. 2A and 2B are flowcharts of software development workflows in accordance with an embodiment of the present invention.

FIG. 3 is an example of source code optimization in accordance with an embodiment of the present invention.

FIG. 4 is a flowchart of the steps of a compiler program or function in the computer of FIG. 1, in accordance with an embodiment of the present invention.

FIG. 5 is a functional block diagram of a computer system in accordance with an embodiment of the present invention.

### DETAILED DESCRIPTION

As discussed previously, programmers are taught when writing source code to declare variables at the beginning of the source code to help the compiler allocate the proper resources. As the compiler assembles the source code, this design may be inefficient because many variables, data types, “memory space”, disk access, database connections, etc., are allocated for use at the top of the routines that use them. However, even though a declared variable may be declared at the beginning of the source code, depending upon user inputs the declared variable is not used in certain instances. Thus, unnecessary and unused allocations of memory, space and other resources are created when they are not needed. This leads to performance decreases for the user.

Thus, in a preferred embodiment of the invention the compiler program solves the aforementioned problem by moving declared variables to a location just before first use of said declared variable. By doing so, this ensures that if the declared variable is allocated space in memory, processing resources, etc., the declared variable will use that allocation and the allocation of resources will not go to waste. The proximity of the location of the declaration of the variable to the location of first use of the variable will be so close that no other processes, statements, etc., in the code could end the program between the declaration of the variable and the location of the first use of the variable.

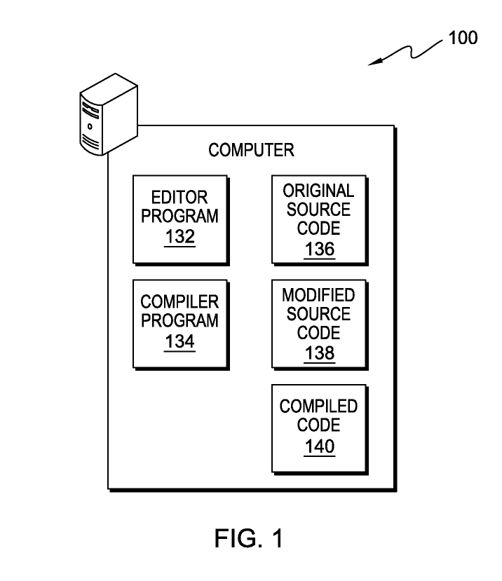

Referring now to FIG. 1, a functional block diagram of computer 100 in accordance with an embodiment of the present invention is shown. In various alternative embodiments, computer 100 can include access to a network, a separate programming device, or a software development server. The network can be, for example, a local area network (LAN), a wide area network (WAN) such as the Internet, or a combination of the two, and can include wired or wireless connections. In general, the network can be any combination of connections and protocols that will support communications via various channels between a programming device and a computer in accordance with an embodiment of the invention.

In various embodiments, computer 100 can include a laptop, tablet, or netbook personal computer (PC), a desktop computer, a personal digital assistant (PDA), a smart phone, a mainframe computer, or a networked server computer. Further, computer 100 can be a computing system utilizing clustered computers and components to act as single pool of seamless resources when accessed through the network, or can represent one or more cloud computing datacenters. In the depicted embodiment, the current technique is implemented entirely in one device.

A user may utilize a client program (not shown) to issue commands to editor program 132 and compiler program 134 to edit and compile original source code 136, which is a version of source code under development. In particular, the client program can interact with editor program 132, which is used to edit original source code 136. For example, in one embodiment the client program and editor program 132 can be included in an integrated development environment (i.e., an IDE). Further, the client program can interact with compiler program 134, to instruct the compiler program to compile original source code 136 into, for example, modified source code 138.

Computer 100 includes original source code 136. Further, computer 100 includes modified source code 138 and compiled code 140, which are different versions of the compiled code under development. In particular, modified source code 138 is changed from the original source code 136 but is still in the form of source code. Alternatively, the compiled code 140 is changed from the original source code 136 and is compiled to be used as an executable program.

In one embodiment, a user can access computer 100 remotely via the network. Computer 100 includes the aforementioned editor program 132, compiler program 134, original source code 136, modified source code 138 and compiler source code 140 for utilization by a user via the network. The user can access the network using a separate computer, a separate programming device or a software development server.

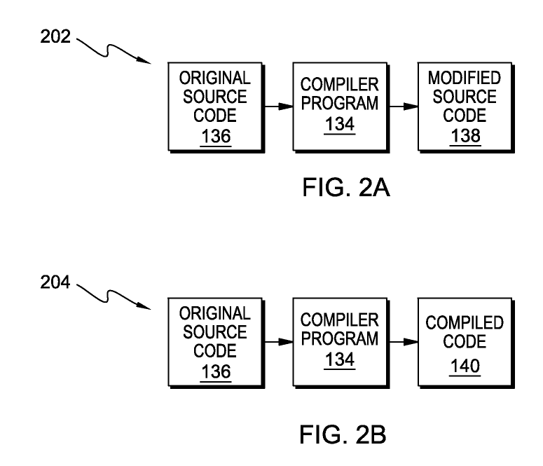

FIGS. 2A and 2B show flowcharts of software development workflows 202 and 204 in accordance with an embodiment of the present invention. In one embodiment, prior to the beginning of workflows 202 and 204, editor program 132 is used to produce original source code 136. For example, original source code 136 can be produced as a user enters program lines, instructions, or statements into computer 100. In particular, program lines, instructions, or statements can include code written in a programming language such as C, Java, or Lisp, for example. A user can invoke workflows 202 and 204 upon the completion of an editing task. In another embodiment, workflows 202 and 204 can be invoked automatically under the control of another program.

Turning now to FIG. 2A, workflow 202 depicts the utilization of compiler program 134 in the creation of modified source code 138 using original source code 136 as its input. First, compiler program 134 reads original source code 136. Next, compiler program 134 produces modified source code 138 from original source code 136 by moving variable declarations and placing the declarations in optimal positions in relation to the declared variables' position of first use. Modified source code 138 is output and is still in source code form. The user can continue to format modified source code 138 in editor program 132 until the modified source code is finalized.

Turning now to FIG. 2B, workflow 204 depicts the utilization of compiler program 134 in the creation of compiled code 140 using original source code 136 as its input. First, compiler program 134 reads original source code 136. Next, compiler program 134 optimizes original source code 136 to locate variable declarations in optimal positions in relation to the declared variables' position of first use. Finally, compiler program 134 compiles original source code 136 to output compiled code 140. Compiled code 140 may include machine language instructions suitable for execution on a microprocessor. In another embodiment, compiled code 140 includes bytecode suitable for execution on a virtual machine (e.g., on a Java virtual machine, etc.).

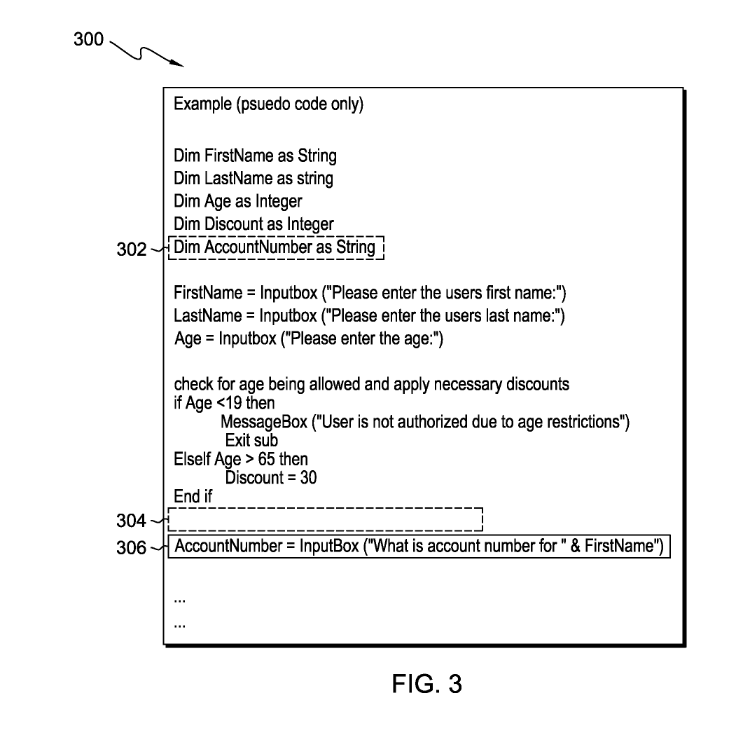

FIG. 3 shows source code 300 and an example of potential optimization of the source code in accordance with an embodiment of the present invention. It should be noted that source code 300 is being used as an example, only the allocation of resources of the declared variable AccountNumber is being optimized, and all other variables are not being optimized. First, compiler program 134 determines original location 302 of the variable declaration of AccountNumber. Second, compiler program 134 finds location 304 that is located preceding location of first use 306 of the declared variable AccountNumber. Third, compiler program 134 moves the declared variable AccountNumber from original location 302 to location 304.

Here, the variable declaration of AccountNumber is being moved from original location 302 to location 304 that is preceding location of first use 306 of the declared variable AccountNumber. In this example, the saving involved with memory and computer processing utilization is associated with the allocation of resources for the declared variable AccountNumber. By moving from original location 302 of the variable declaration of AccountNumber to location 304, resources are saved when the user inputs an age that is below nineteen. If the user's age is below nineteen then the program ends without resources being allocated to variable AccountNumber. While this example shows the resource savings on a very small scale, major gains can be seen when working with database connections, creation of objects, interfaces, etc.

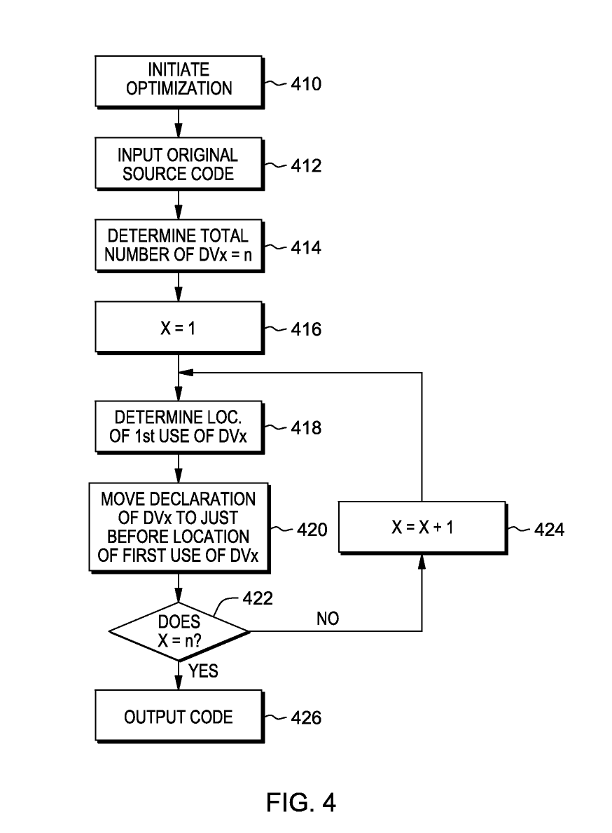

FIG. 4 shows a function of compiler program 134 for optimizing the location of declared variables, in accordance with an embodiment of the present invention. Alternatively, this optimization process could take place anywhere in editor program 132, compiler program 134 or any other programs not shown but that will be apparent to those of ordinary skill in the art without departing from the scope and spirit of the described embodiments. In step 410, compiler program 134 initiates the optimization function. In one embodiment, this may be in response to a user directive. In another embodiment, this function may be automatically initiated by compiler program 134 when transforming source code 136 into an executable program. In step 412, compiler program 134 receives original source code 136. For example, compiler program 134 receives original source code 136 directly from editor program 132 or receives original source code from a user input.

In step 414, compiler program 134 determines the total number of variable declarations n in original source code 136. For example, compiler program 134 counts the total number of separate and individual declarations in original source code 136 and sets the value of n equal to that number. In step 416, variable x is set at a value of 1. Variable x may be used by compiler program 134 as a placeholder so the compiler program always knows what declaration it is currently optimizing. For example, when compiler program 134 is in the process of optimizing the fifth declaration in original source code 136, x will have a value of five.

In step 418, compiler program 134 determines the location of the first use of Declared Variable (DV)ₓ associated with the variable declaration. Compiler program 134 starts at the beginning of original source code 136, moves through the lines of code until the first instance of use of DVₓ, and records the location of first use of DVₓ. For example, this location of first use for DVₓ can occur at the beginning of original source code 136, the middle of original source code, or at any location within original source code. In an alternative embodiment, compiler program 134 continues to search through original source code 136 even after the location of first use of DVₓ is determined so as to locate any other locations of first use that might occur in scenarios of multiple locations of first use of DVₓ, as discussed below.

In step 420, compiler program 134 moves the declaration of DVₓ to a line preceding the location of first use of DVₓ. Compiler program 134 moves all lines of code including the location of first use of DVₓ down one line leaving an empty line preceding the location of first use of DVₓ, adds the declaration of DVₓ into the blank line, and removes the original declaration of DVₓ from original source code 136. In an alternative embodiment, compiler program 134 moves the declaration of DVₓ to any location preceding the location of first use of DVₓ. The location of this move allows for DVₓ to be allocated resources only when DVₓ will be used. In another embodiment, compiler program 134 moves the declaration of DVₓ to an empty line of code preceding the location of first use of DVₓ.

In yet another embodiment, compiler program 134 moves the declaration of DVₓ to a location at the beginning of a subprogram that can be separately called and contains the location of first use of DVₓ. For example, compiler program 134 may determine that a subprogram contains the location of first use of DVₓ, move all code in the subprogram down one line leaving a blank line at the top of the subprogram, add the declaration of DVₓ into the blank line, and remove the original declaration of DVₓ from original source code 136. By moving the declaration of DVₓ to the top of the subprogram, the allocation of resources for DVₓ still occurs at a time before the location of first use of DVₓ, ensures that resources are available for DVₓ when DVₓ is used the first time, and that DVₓ will not be allocated resources that are not used. As used herein, the term “subprogram” may also refer to a subroutine, a function found internal to original source code 136, or any other smaller section of code found inside the larger original source code.

In step 422, compiler program 134 determines if variable x is equal to variable n. This is how compiler program 134 determines if all of the DVs have been processed. If variable x is not equal to variable n then compiler program 134 has not finished processing all of the DVs and moves on to step 424. However, if variable x is equal to variable n then compiler program 134 has finished processing all of the DVs.

In step 424, variable x is increased by an increment of one in the equation of “x=x+1”. Compiler program 134 then cycles back to step 418 and repeats steps 418, 420 and 422 until the compiler program determines that variable x is equal to variable n. When this occurs, compiler program 134 moves on to step 426. In step 426, compiler program 134 outputs modified source code 138 for use. For example, a user can now further refine modified source code 138. In an alternative embodiment, compiler program 134 completes the optimization of original source code 136 and then compiles the code as shown in workflow 204 to output compiled code 140. As discussed previously, compiled code 140 includes machine language instructions suitable for execution on a microprocessor, while in another embodiment, compiled code includes bytecode suitable for execution on a virtual machine (e.g., on a Java virtual machine, etc.).

In an alternative embodiment, steps 418 and 420 determine if there are multiple locations of first use of DVₓ, such as in logic switches. For example, in “IF . . . ELSE IF . . . ” and “SWITCH CASE . . . ” statements, the location of the first use of DVₓ is dependent upon the data entered. Here, compiler program 134 determines the multiple locations of first use of DVₓ in step 418. Compiler program 134 counts and records the multiple locations of first use and determines an optimized location to move the declarations of DVₓ. As discussed previously, compiler program 134 then moves the declaration of DVₓ to the first open line in original source code 136 before the multiple locations of first use of DVₓ and deletes the original declaration of DVₓ. In an alternative embodiment, as discussed previously, compiler program 134 adds blank lines in original source code 136 just before the multiple locations of first use of DVₓ, moves the declaration of DVx to the blank lines, and deletes the original declaration of DVₓ.

In an alternative embodiment, instead of the location of declared variables being optimized in original source code 136 in order to save computer resources, the location of other functions can be optimized in order to save computer resources in an event that the functions are not initiated. For example, original source code 136 might require access to multiple databases. Instead of accessing the databases at the beginning of original source code 136, compiler program 134 may optimize the location of the declaration of access to said databases. Here, access to the database would occur only when original source code 136 required access to said databases. This could occur, for example, in databases that are split between male and female and original source code 136 was only required to access one of the databases. The advantage in this embodiment is the time and resources required to access both databases as compared to the singular database. Alternatively, a person having ordinary skill in the art would realize that this optimization can occur for other functions such as accessing e-mail servers, writing a file to disk, requesting information from a server, etc., in order to save computer resources in an event that the functions are not initiated.

The above mentioned embodiments provide multiple advantages over the prior art. First, there are savings in allocation of memory. Here, since the DV is declared as close to the location of first use of the DV, the DV will only be allocated memory for use if the DV will actually be used. This ensures that memory is not allocated for the declaration of a DV that is never used. Second, there is a savings in allocation of processor resources. Here, when compiled code 140 that is executable is executed by a user, the processor will only spend resources on allocating DV if the DV is about to be used as opposed to original source code 136 where all allocations of DV occur at the beginning of original source code. Original source code 136 is very front end heavy on processing resources because as soon as the file is executed the processor must declare all DVs. In an embodiment of the previously described invention, these processing resource allocations are spread throughout the executable file, the DVs are only declared if needed, and no wasted processing resources are used on DVs that are not needed.

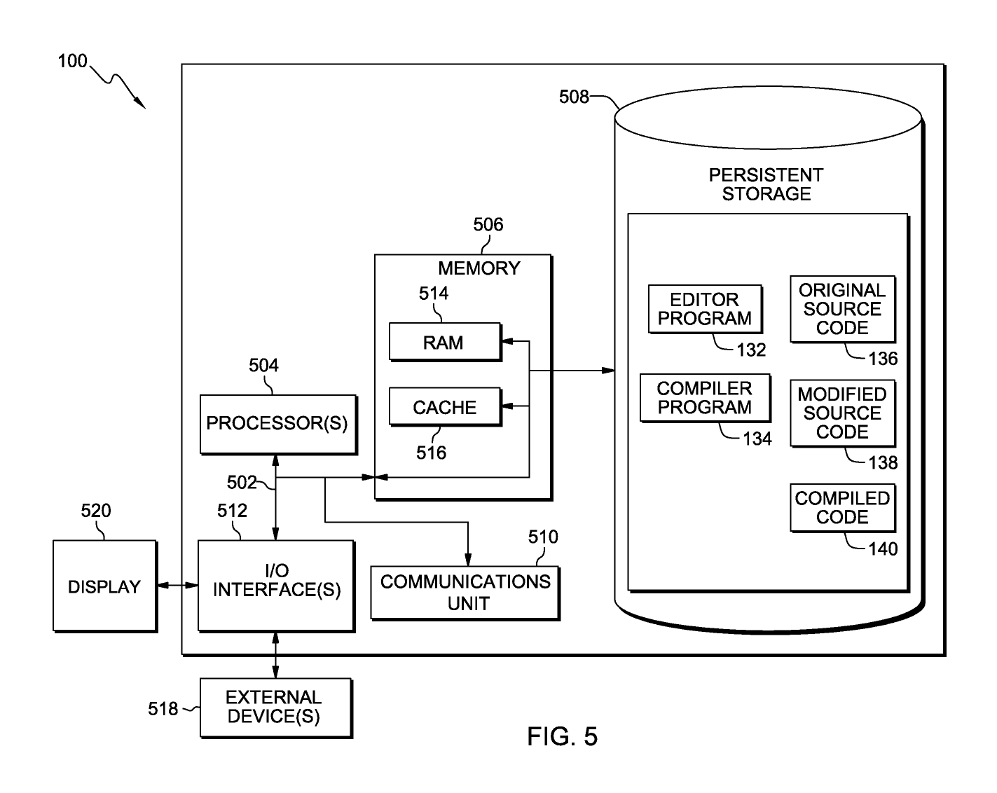

FIG. 5 depicts a block diagram of components of computer 100 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computer 100 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 514 and cache memory 516. In general, memory 506 can include any suitable volatile or non-volatile computer readable storage media.

Editor program 132 and compiler program 134 are stored in persistent storage 508 for execution by one or more of the respective computer processors 504 via one or more memories of memory 506. In this embodiment, persistent storage 508 includes a magnetic disk. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of network 110 and software development server 130. In these examples, communications unit 510 includes one or more network interface cards. Communications unit 510 may provide communications through the use of either or both physical and wireless communications links. Editor program 132 and compiler program 134 may be downloaded to persistent storage 508 through communications unit 510.

I/O interface(s) 512 allows for input and output of data with other devices that may be connected to programming device 120. For example, I/O interface 512 may provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., editor program 132 and compiler program 134, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for optimizing code, the method comprising the steps of:
identifying a variable declaration in a source code file;
identifying a variable associated with the variable declaration;
determining, by one or more computer processors, a location of first use of the variable in the source code file;
determining, by one or more computer processors, an empty line located preceding the location of first use of the variable in the source code file; and
moving the variable declaration to the empty line.

2. (canceled)

3. (canceled)

4. (canceled)

5. (canceled)

6. The method of claim 1, further comprising:
identifying a statement in the source code file initiating a database;
determining, by one or more computer processors, a location of first use of the database; and
moving the statement to a location before the location of first use of the database.

7. The method of claim 1, further comprising:
identifying a statement in the source code file initiating a function;
determining, by one or more compute processors, a location of first use of the function; and
moving the statement to a location before the location of first use of the function.

8. A computer program product for optimizing code, the computer program product comprising:
program instructions stored on the one or more computer readable storage media, the storage instructions comprising:
program instructions to identify a variable declaration in a source code file;
program instructions to identify a variable associated with the variable declaration;
program instructions to determine a location of first use of the variable in the source code file;
program instructions to determine an empty line located preceding the location of first use of the variable in the source code file; and
program instructions to move the variable to the empty line.

9. (canceled)

10. (canceled)

11. (canceled)

12. (canceled)

13. The computer program product of claim 8, further comprising program instructions, stored on the one or more computer readable storage media, to:
identify a statement in the source code file initiating a database;
determine a location of first use of the data base; and
move the statement to a location before the location of first use of the database.

14. The computer program product of claim 8, further comprising program instructions, stored on the one or more computer readable storage media, to:
identify a statement in the source code file initiating a function;
determine a location of first use of the function; and
move the statement to a location before the location of first use of the function.

15. A computer system for optimizing code, the computer system comprising:
one or more computer processors
one or more computer readable storage media; and
program instructions, stored on the one or more computer readable storage media for execution by at least one of the one or more computer processors, the program instructions comprising:
program instructions to identify a variable declaration in a source code file;
program instructions to identify a variable associated with the variable declaration;
program instructions to determine a location of first use of the variable in the source code file;
program instructions to determine an empty line located preceding the location of first use of the variable in the source code file; and
program instructions to move the variable to the empty line.

16. (canceled)

17. (canceled)

18. (canceled)

19. (canceled)

20. The computer system of claim 15, further comprising program instructions, stored on the one or more computer readable storage media for execution by the at least one of the one or more computer processors, to:
identify a statement in the source code file initiating a function;
determine a location of first use of the function; and
move the statement to a location before the location of first use of the function.

21. The method of claim 1, wherein the determined empty line is an empty line that exists in the source code file.

22. The computer program product of claim 8, wherein the determined empty line is an empty line that exists in the source code file.

23. The computer system of claim 15, wherein the determined empty line is an empty line that exists in the source code file.
